(19) United States
(12) Patent Application Publication
(10) Pub. No.: US 2014/0313133 A1
(43) Pub. Date: Oct. 23, 2014

(54) WIRELESS CONFIGURABLE KEYPAD SYSTEM AND METHOD

(71) Applicant: Turning Technologies, LLC, Youngstown, OH (US)

(72) Inventors: Patrick Bean, Youngstown, OH (US); Jeff Cunningham, Hermitage, PA (US); Josh Blackann, Youngstown, OH (US)

(73) Assignee: Turning Technologies, LLC, Youngstown, OH (US)

(21) Appl. No.: 14/202,040

(22) Filed: Mar. 10, 2014

Related U.S. Application Data
(60) Provisional application No. 61/777,401, filed on Mar. 12, 2013.

(51) Int. Cl. G06F 3/023

(52) U.S. Cl. CPC G06F 3/0233
USPC 345/168

(57) ABSTRACT

A method for communicating with a computer program application using a remote wireless keypad includes unlocking a receiver responsive to receiving data indicative of a request to unlock the receiver. The method further includes associating the receiver with a keypad comprising at least one button. The method further includes associating the at least one button of the associated keypad with a function based on received data indicative of a keypad configuration. The method further includes receiving data, via the receiver, indicative of a button on the keypad being pressed. The method further includes communicating data representative of a function associated with the pressed button to a computer program application.

### CROSS-REFERENCE TO RELATED APPLICATIONS

This application claims priority from U.S. Provisional Patent Application No. 61/777,401 filed on Mar. 12, 2013, which is incorporated by reference herein in its entirety.

### BACKGROUND

Computing devices have become prevalent in a variety of industries for use in a variety of applications. Depending on the industry and the application, however, inputting data into the computing device may be challenging, inconvenient, or time consuming. For example, a user performing a task at a first location may need to input data into a computing device while performing the task. It may not be practical or feasible, however, to position the computing device at the same location. Thus, a user may be required to turn away from the task toward the computing device to input the data; or the user may be required to physically go to a different location to get to the computing device to input the data. This may create inefficiencies for the user, as the user may need to stop performing the task temporarily while turning attention to the computing device.

Wireless keyboards (and keypads) are currently available. However, existing wireless keyboards may not operate on the same wireless frequency within proximity of each other without causing interference. Adjusting the frequencies for multiple wireless keyboards when numerous users are working within proximity of each other may be tedious, time consuming, and unfeasible. Additionally, the keys on typical existing wireless keyboards are not configurable. Thus, a user may have a keyboard with 100 or more keys, while the user may only require ten or fewer keys to input data corresponding to a particular task.

### SUMMARY

In one embodiment, a method for communicating with a computer program application using a remote wireless keypad includes unlocking a receiver responsive to receiving data indicative of a request to unlock the receiver. The method further includes associating the receiver with a keypad comprising at least one button. The method further includes associating the at least one button of the associated keypad with a function based on received data indicative of a keypad configuration. The method further includes receiving data, via the receiver, indicative of a button on the keypad being pressed. The method further includes communicating data representative of a function associated with the pressed button to a computer program application.

In another embodiment, a computer program product is provided for communicating with a computer program application using a remote wireless keypad, the computer program product comprising: first program instructions configured to associate a keypad with a receiver; second program instructions configured to associate at least one button on the keypad with a predefined function; third program instructions configured to receive notification that the at least one button on the keypad was pushed; and fourth program instructions configured to communicate the predefined function associated with the at least one button.

In another embodiment, a system is provided for communicating with a computer program application using a remote wireless keypad, the system comprising: a keypad configured to communicate radio frequency (“RF”) signals corresponding to a button click; a receiver configured to receive the RF signal and to interface with a computing device via USB; and a keypad program executing on the computing device and configured to interpret the RF signal and to communicate a function associated with the button click to a second program.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an embodiment of an example wireless configurable keypad.

FIG. 2 illustrates an embodiment of an example wireless receiver.

FIG. 3 illustrates a block diagram of an example keypad application program.

FIG. 4 illustrates a screen shot of an example keypad application program.

FIG. 5 is a flow chart illustrating an example wireless configurable keypad method.

FIG. 6 is a block diagram of an example computing system.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

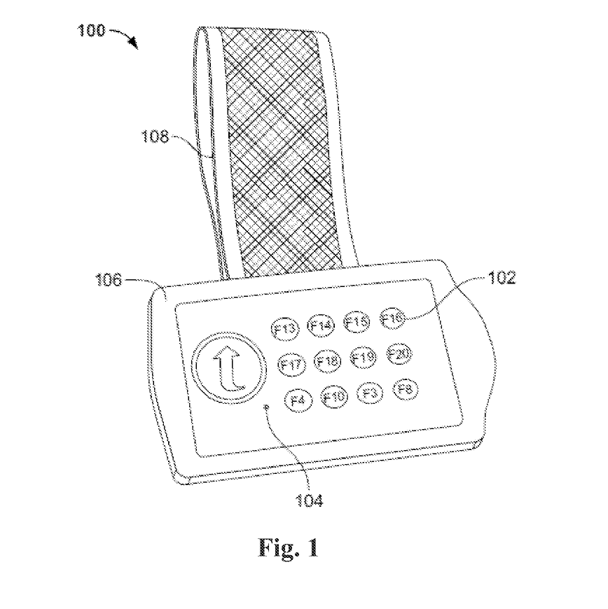

FIG. 1 illustrates an example embodiment of a wireless configurable keypad (a “keypad”) 100. Keypad 100 may also be referred to as a response card. Keypad 100 includes a number of buttons 102 for receiving input from a user (not shown). As shown, keypad 100 includes 12 keys or buttons 102; however, keypad 100 may include any number of suitable buttons 102. In addition, although buttons 102 are illustrated in keypad 100 as being labeled F13, F14, F15, and so on, buttons 102 may be labeled in any suitable way. For example, buttons 102 may be labeled with numbers, letters, symbols, or any combination thereof.

Keypad 100 may include a light 104 configured to illuminate when a button 102 is pressed. Light 104 provides the user with feedback and confirms that button 102 is working. If light 104 does not illuminate after a button push, the user may be alerted that the keypad 100 needs a new battery, for example. Although a single light 104 is illustrated, other suitable forms of user feedback may also or alternatively be used, such as multiple lights, an audible alert, a vibrating alert, and the like. In one embodiment, an LCD (not shown) may be used to provide user feedback. In one embodiment, the LCD may also be used as an interface for receiving input from the user. Thus, buttons 102 may be digital representations on the LCD screen.

Keypad 100 may also include a protective cover or holder 106. Keypad 100 may also include a strap 108 to allow a user to secure the keypad 100 to an arm, for example. By having the keypad 100 secured to an arm with the strap 108, the user may click a button 102 without turning focus away from an activity or task being performed. For example, a user performing a function on an assembly line in a factory may push a button 102 on keypad 100 to enter data into a computing system about a defect detected on the assembly line, without having to stop performing the function at the assembly line, and without having to stop the assembly line.

Keypad 100 may also include a wireless transmitter (not shown), such as an RF transmitter, that is configured to transmit signals corresponding to buttons 102 pressed on the keypad 100. For example, the RF transmitter may transmit a first signal when a first button is pressed, and may transmit a second signal when a second button is pressed. Although keypad 100 is described to communicate using RF, keypad 100 may also communicate using other suitable protocols such as 802.11, Bluetooth, Zigbee, 3G, 4G, or other similar wireless communication protocols.

Keypad 100 may have an assigned identification number so that keypad 100 can be distinguished from other keypads operating within the vicinity. Keypad 100 includes the identification number in all transmitted signals.

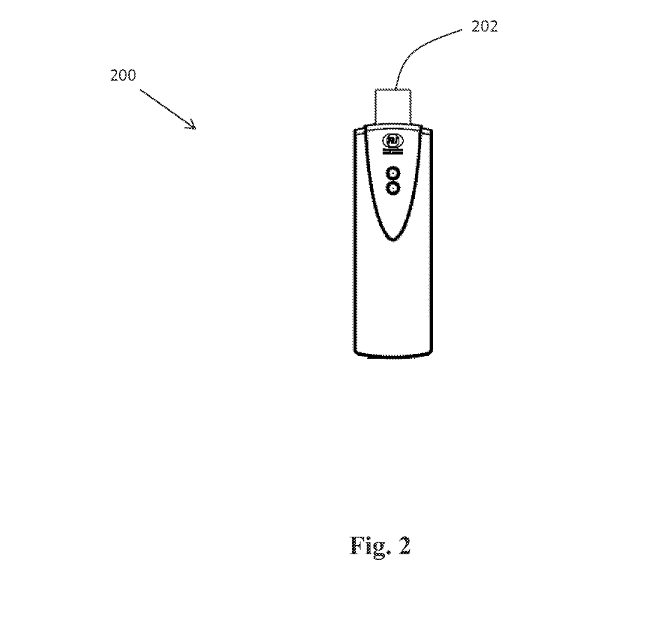

FIG. 2 illustrates an example embodiment of a wireless receiver (a “receiver”) 200. Receiver 200 includes a wireless receiver, such as an RF antenna (not shown), configured to receive wireless signals corresponding to, e.g., buttons 102 being pressed at keypad 100. For example, when a user pushes a first button at keypad 100, receiver 200 receives a first signal, and when the user pushes a second button at keypad 100, receiver 200 receives a second signal. Thus, receiver 200 is able to distinguish between different button 102 pushes on the keypad 100.

Receiver 200 may further include a USB interface 202 for interfacing with a computing device and for communicating received signals from a keypad 100 to the computing device. Although receiver 200 is illustrated as having a USB interface 202, receiver 200 may be configured to communicate with a computing device via another similar type of communication port, or hub such as Micro USB, an audio jack, or the like.

Although a single keypad 100 and receiver 200 are described, multiple keypads may be used within proximity of one another without interfering with each other operationally. In one embodiment, a specific receiver is paired up or associated with a keypad such that the computing device interfacing with the receiver only responds to RF signals received from that particular paired keypad, even though all of the keypads operating within proximity of one another may be using the same radio frequency for communicating. The pairing of a keypad 100 with a receiver 200 may be facilitated with a keypad application program, configured to be executed by a computing device interfacing with a receiver 200. In one embodiment, multiple keypads may be paired with a single receiver.

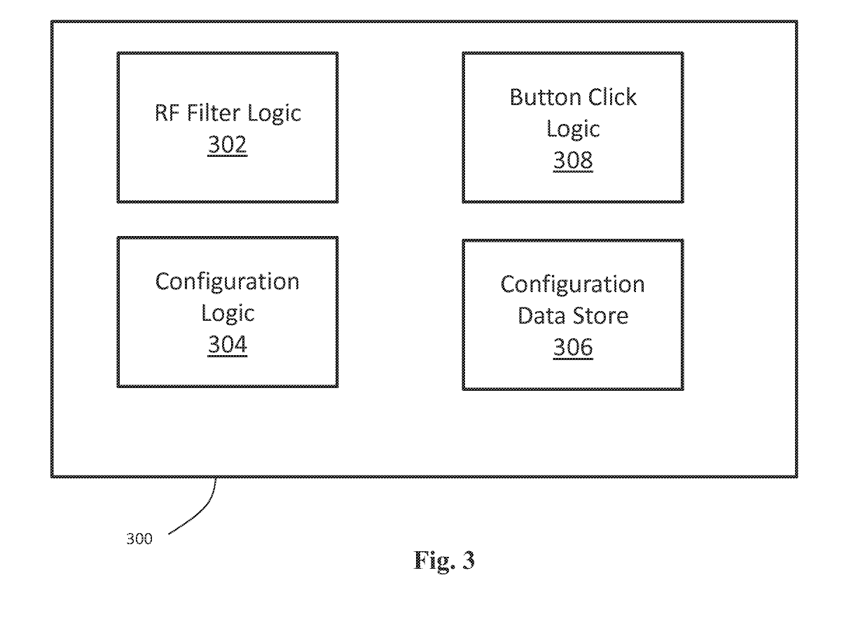

FIG. 3 illustrates a block diagram of an example keypad application 300. When executed by a computing device, keypad application 300 may enable a user to configure a receiver 200 and to specify which RF signals are to be responded to and how to interpret the RF signals. Keypad application 300 includes RF filter logic 302 for receiving and filtering RF signals according to a configuration. Keypad application 300 may include configuration logic 304 for configuring keypad application 300.

Keypad application 300 may be configured to operate in either a locked mode or an unlocked mode. For example, in an unlocked mode, keypad application 300 may be configurable; in an unlocked mode, keypad application 300 may not be configurable.

Configuration logic 304 may be configured to instruct RF filter logic 302 to listen for and receive RF signals from, e.g., any keypad 100 via receiver 200 when keypad application 300 is in an unlocked mode. RF filter logic 302 may be configured to determine an identification number of an RF signal currently being received, thus being configured to identify keypad 100 transmitting the RF signal.

When keypad application 300 is switched to lock mode, configuration logic 304 may be configured to associate or pair receiver 200 with an identified keypad 100. Configuration logic 304 may create the association by storing in configuration data store 306 the identification number of the identified keypad 100. In one embodiment, a keypad 100 for pairing may be specified by a user or an administrator.

Configuration logic 304 may be configured to prevent a user from making any configuration changes while keypad application 300 is in lock mode. In such an embodiment, for additional configuration changes to be made, keypad application 300 must be again unlocked.

While in locked mode, RF filter logic 302 may be further configured to compare the identification number of all received RF signals to the stored identification number. RF filter logic 302 may be configured to ignore the RF signal if the identification numbers do not match.

Configuration logic 304 may also be configured to enable a user or an administrator to customize the buttons on an associated keypad, while the receiver is in the unlocked mode. Configuration logic 304 may be configured to receive data representative of a selection of computer keyboard keys or functions to associate with, e.g., specific buttons on a keypad 100. For example, a user may choose to configure a first button on a keypad 100 to correspond to the ‘F1’ key on a keyboard, a second button on a keypad 100 to correspond to the ‘A’ key on a keyboard, and so on. Thus, a user may configure buttons on a keypad 100 to correspond to any subset or combination of keys of a keyboard. The associations may be stored by configuration logic 304 in configuration data store 306.

Keypad application 300 also includes button click logic 308 that may be configured to send a corresponding key click, or data representative of an associated function, to the computer system when a button is pressed on the keypad 100, as if the same key was pressed, or function initiated, on a wired keyboard located at the computing system. For example, if a first button on a keypad 100 is configured to correspond to the ‘A’ key, button click logic 308 may be configured to notify the computing system that an ‘A’ key was pressed when a user pushes on the first button on the keypad 100.

Button click logic 308 may determine the corresponding key click to send to the computing system by determining the identification number of the received RF signal and locating the associated key stored in configuration data store 306. In one example, the associations stored in configuration data store 306 are specific for a particular keypad-receiver pair. Thus, a user or an administrator may choose to configure, and therefore interpret, signals differently depending on from which keypad the signals are being received.

Button click logic 308 may be further configured to send the corresponding key click to an application program that is currently executing and in focus on the computing system. Thus, for example, if a word processing program application is open and in focus on the computing system, button click logic 308 may cause a letter ‘A’ to appear in the word processing application when a first button on a keypad is clicked, if the first button is configured to correspond to an ‘A’ key. Similarly, if a function key such as ‘F1’ is configured to perform a defined function within a software application, pressing a button on the keypad that is associated with the ‘F1’ key may cause the same defined function to be performed when the first button on the keypad is configured to be associated with the ‘F1’ key.

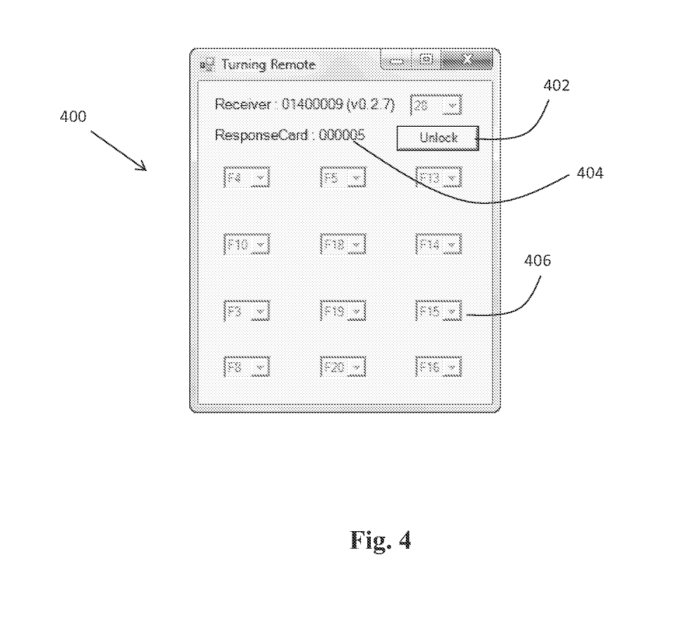

FIG. 4 illustrates an example user interface 400 of a keypad application program 300. User interface 400 has an unlock button 402 which may be used to initiate configuration logic 302 when clicked. User interface 400 has a lock button (not shown) which may be used to terminate execution of configuration logic 302 to place the receiver in a lock mode. In one example, unlock button 402 and the lock button may be the same button. For example, after a user clicks on the unlock button 402, the label on the button may automatically change to “lock.” The locking and unlocking of a receiver may be implemented in other suitable ways, some of which may not include explicitly labeling a user interface button with a “lock” or “unlock” label.

User interface 400 also includes an ID display 404 configured to display an identification number associated with a keypad 100 when a receiver 200 receives an RF signal from the keypad 100. This configuration may provide the user with feedback and may identify the keypad 100 for the user. In one embodiment, user interface 400 may enable a user or an administrator to specify a keypad 100 with which to associate a receiver. Accordingly, display 404 may be configured to display an identification number associated with a user selected keypad 100.

User interface 400 may have a number of drop-down lists 406 corresponding to the number of buttons 102 on a keypad 100. Drop-down lists 406 contain a selection of computer keyboard keys with which a user or an administrator may wish to associate keypad buttons 102.

Although drop-down lists and buttons are illustrated as user interface elements for enabling a user to interact with the keypad application 300 and, in turn, to configure the receiver 200, other suitable interface elements may also or alternatively be used. For example, check boxes, list boxes, radio buttons, menus, and the like may be used.

In one example, a receiver 200 may include firmware configured to compare an identification number of a received RF signal to a preconfigured identification number, and to ignore RF signals that do not include the preconfigured identification number. In such an example, the keypad application 300 may store the identification number of the paired keypad 100 either in memory of the computing device or in memory of the receiver 200. Thus, the task of filtering the received RF signals to process only those received from a selected or paired keypad 100 may be shifted away from the keypad application and to the receiver 200.

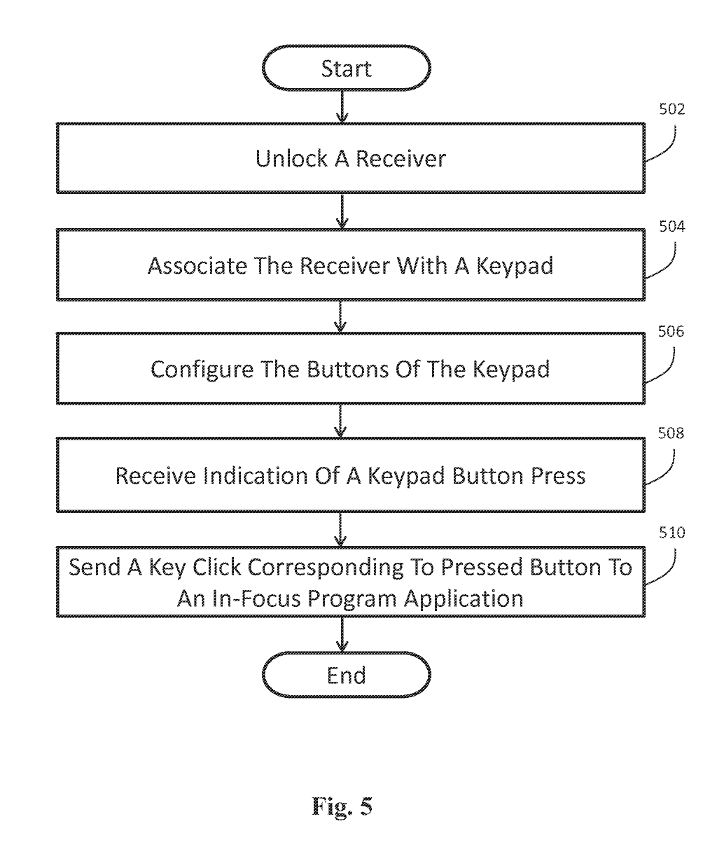

FIG. 5 is a flow chart illustrating an example wireless configurable keypad method 500. As shown in FIG. 5, a keypad application 300 receives notification from a user to switch a receiver 200 to unlock mode (step 502). The keypad application 300 unlocks the receiver 200 (step 504). The keypad application 300 associates the receiver 200 with a keypad 100 (step 506). The keypad application 300 associates the buttons 102 of the keypad 100 according to a configuration received from a user interface 400 (step 508). The keypad application 300 receives indication that a button 102 on the keypad 100 was pressed (step 510). The keypad application 300 sends a key click corresponding to the pressed button, based on the button associations, to an in focus program application (step 512).

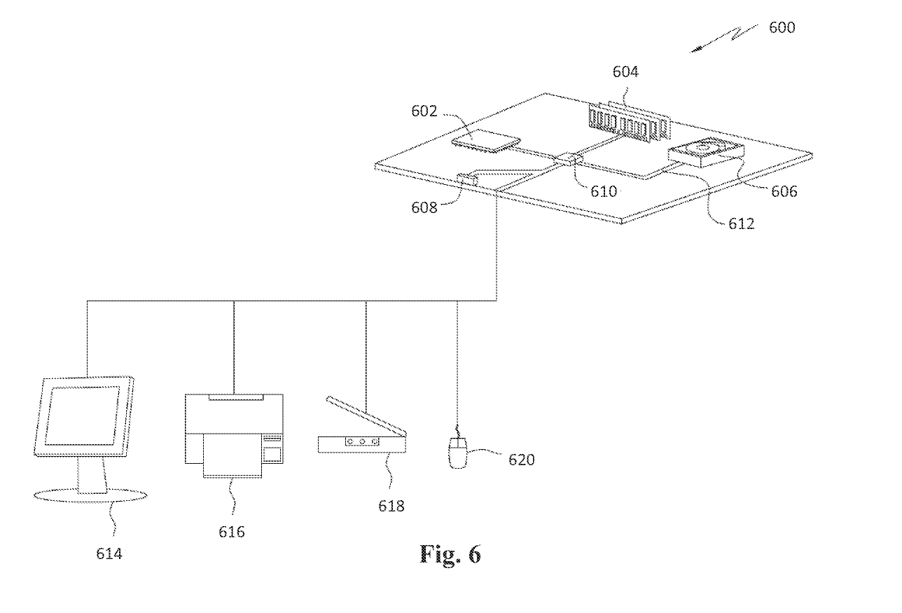

FIG. 6 is a block diagram of an example computing system 600. The example computing system 600 is intended to represent various forms of digital computers, including laptops, desktops, handheld computers, tablet computers, servers, and other similar types of computing devices. As shown, computing system 600 includes a processor 602, memory 604, a storage device 606, and a communication port 608, operably connected by an interface 610 via a bus 612.

Processor 602 processes instructions, via memory 604, for execution within computing system 600. In an example embodiment, multiple processors along with multiple memories may be used.

Memory 604 may be volatile memory or non-volatile memory. Memory 604 may be a computer-readable medium, such as a magnetic disk or optical disk. Storage device 606 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 604 or storage device 606.

Computing system 600 may be coupled to one or more input and output devices such as a display 614, a printer 616, a scanner 618, and a mouse 620.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. A method for communicating with a computer program application using a remote wireless keypad, the method comprising:
unlocking a receiver responsive to receiving data indicative of a request to unlock the receiver;
associating the receiver with a keypad comprising at least one button;
associating the at least one button of the associated keypad with a function based on received data indicative of a keypad configuration;
receiving data, via the receiver, indicative of a button on the keypad being pressed; and
communicating data representative of a function associated with the pressed button to a computer program application.

2. The method of claim 1, further comprising:
receiving data indicative of a request to lock the receiver; and
disabling user interface functions associated with configuring the receiver.

3. The method of claim 1, wherein the step of associating the receiver with a keypad comprises storing an association in a database.

4. The method of claim 1, wherein the step of associating the receiver with a keypad comprises communicating the association to firmware embedded in the receiver.

5. The method of claim 1, wherein the step of associating the receiver with the keypad comprises receiving data indicative of a keypad selection and associating the receiver with the selected keypad.

6. The method of claim 1, further comprising filtering the indication that a button on a keypad was pressed according to a configured keypad identification number.

7. A computer program product for communicating with a computer program application using a remote wireless keypad, the computer program product comprising:
first program instructions configured to associate a keypad with a receiver;
second program instructions configured to associate at least one button on the keypad with a predefined function;
third program instructions configured to receive a notification that the at least one button on the keypad was pushed; and
fourth program instructions configured to communicate the predefined function associated with the at least one button.

8. The computer program product of claim 7, wherein the first program instructions are further configured to store the association in a computer tangible storage device, and wherein the second program instructions are configured to store the association in a computer tangible storage device.

9. The computer program product of claim 7, wherein the third program instructions are further configured to receive the notification via an RF signal.

10. The computer program product of claim 7, wherein the predefined function is a keyboard click.

11. The computer program product of claim 7, wherein the fourth program instructions are further configured to communicate the predefined function to an in-focus computer application.

12. The computer program product of claim 7, wherein the first program instructions are further configured to communicate the association to firmware embedded in a receiver, and wherein the second program instructions are further configured to communicate the association to firmware embedded in a receiver.

13. A system for communicating with a computer program application using a remote wireless keypad, the system comprising:
a keypad configured to communicate RF signals corresponding to a button click;
a receiver configured to receive the RF signal and to interface with a computing device via USB; and
a keypad program executing on the computing device and configured to interpret the RF signal and to communicate a function associated with the button click to a second program.

14. The system of claim 13, wherein the keypad is further configured to communicate an identification number embedded in the RF signal.

15. The system of claim 13, wherein the keypad program is further configured to receive a configuration associating a button click to a predefined function, and to store the association in a database.

16. The system of claim 13, wherein the keypad program is further configured to function in a lock mode wherein the keypad cannot be configured.

17. The system of claim 13, wherein the keypad program is further configured to function in an unlocked mode wherein the keypad can be configured.

18. The system of claim 13, wherein the receiver comprises firmware configured to filter RF signals.

19. The system of claim 13, wherein the keypad comprises a protective cover.

20. The system of claim 13, wherein the keypad comprises a wristband.

21. The system of claim 13, wherein the keypad program is configured to communicate the function to a program in-focus at the computing device.
